(19) United States
(12) Patent Application Publication
(10) Pub. No.: US 2006/0280669 A1
(43) Pub. Date: Dec. 14, 2006

(54) Waste conversion process

(76) Inventor: Fred L. Jones, Canton Township, MI (US)

Correspondence Address: Gerald R. Black, 30320 Southfield Road, Southfield, MI, 48076, US

(21) Appl. No.: 11/149,384

(22) Filed: Jun. 10, 2005

(51) Int. Cl. C01B 31/02; C10B 51/00; C10B 1/06

(52) U.S. Cl. 423/445 R; 202/95; 202/117; 202/136

(57) ABSTRACT

A process for the preparation of high quality char from organic waste materials. The waste is first sorted to remove recyclable inorganic materials of economic value (metals, glass) and other foreign materials that would be detrimental to the quality of the final product (stone, sand, construction debris, etc.). After size reduction, the waste is pyrolyzed at a temperature range of 250 to 600° F., in a high capacity, continuous mixer reactor, using in-situ viscous heating of the waste materials, to produce a highly uniform, granular synthetic product similar in energy content and handling characteristics to, but much cleaner burning than, natural coal.

This Patent Application claims priority to PCT Application No. PCT/US2004/038447 entitled “Waste Conversion Process” (Fred L. Jones) filed on 16 Nov. 2004, which is currently pending, which in turn claimed priority to U.S. Provisional Application No. 60/520,509 entitled “Waste Conversion Process” (Fred L. Jones) filed 17 Nov. 2003, which has now lapsed.

### FIELD OF USE

The present invention relates to a process for converting organic waste materials into a carbon-rich char material, more particularly, preparing a synthetic coal of superior quality.

### BACKGROUND OF THE INVENTION

The disposal of solid organic waste materials has been traditionally handled by landfilling. However, landfilling has become less of a solution to waste disposal and more of a means of storing waste until an effective means of disposal or utilization can be developed. The desire to reduce the amount of waste volume landfilled, and to avoid some of the issues associated with less than perfect waste containment in landfills, has led to programs for recycling, composting and incineration of organic waste materials. Each program brings some benefit, but does not represent a full solution for the waste problem. Effective recycling requires economic justification, and most components of the waste stream do not have sufficient economic value to offset their cost of separation and recovery. Composting is effective on some parts of the waste stream, but the majority of the waste is not amenable to compost production. Incineration converts the organic fraction of the waste stream to heat energy which can be used to generate process steam or electricity. However, the high moisture content, variability of composition and physical characteristics of organic waste materials have made incineration systems expensive, inefficient, high maintenance, and unpopular with the general public. What is needed is a system that can alter the chemical and physical characteristics of organic waste in such a way as to make its handling, storage, and utilization fully compatible with existing uses, technology and infrastructure. By far the most likely and logical end user for the calorific value of the waste stream is the fuel industry.

Many have looked to pyrolysis as a means of chemically altering and improving the characteristics of urban waste. Heat is added to the waste materials in an oxygen-free environment, breaking the organic matter into a state of products ranging from mineral matter to carbon-rich charcoal to oil mixtures to non-condensible gases and water vapor. Some have sought to focus on the oil byproducts, looking to the motor fuel industry as a potential market. However, waste pyrolysis oils are not readily compatible with petroleum-based liquid fuels, and therefore require extensive and expensive upgrading to achieve that compatibility.

Others have modified the process to increase production of fuel gases. However, the pyrolysis gases are not compatible with today's natural gas pipeline systems, and must be used on-site. Still others have sought to drive the pyrolysis process to its extreme, yielding a small quantity of concentrated solid carbon. These processes are often characterized by high energy consumption (low thermal efficiency), high reaction temperature, low product yield, long processing time and batch processing. This avenue also requires expensive upgrading, as the char from most pyrolysis processes using urban waste does not have the porosity, surface area and high chemical reactivity desired by the activated carbon market.

Other pyrolysis processes differ in the means by which reaction heat is conveyed to the waste materials, the source of that waste heat, the means by which solids are conveyed within and from the reactor, and the pyrolysis processing conditions themselves. Early processes used the partial combustion of the solid material to produce high temperature gases that directly contacted the fresh waste material. However, these processes have little temperature control, and produce a wide spectrum of byproducts ranging from tars and heavy oils to tight combustible gases, all diluted by the products of partial combustion. While the transfer of heat to the feed material is efficient, the handling of the byproducts is often difficult.

Most pyrolysis processes recognize the desirability of avoiding the heating of the waste by direct contact with hot combustion gases, and have developed a wide range of indirect heating schemes. A few have involved the circulation of hot inert solids from a combustion reactor to the pyrolysis reactor, but most rely on the conduction of heat from combustion products to the waste solids through a heating surface or reactor wall. These designs suffer from several limitations. (1) Pyrolysis heating occurs for material in direct contact with the heating surface, but is much less effective for the remainder of the material, (2) waste must be well stirred in order that all waste have sufficient contact with the heating surface, (3) for heat to flow the wall surface must be significantly higher in temperature than the waste material, making the wall surface a target for high temperature corrosion, (4) reactor designs in which the waste containment is interior to the combustion gas containment must be heavily insulated to avoid loss of valuable heat through the exterior walls rather than through the heating surface to the waste material, (5) the temperature of the combustion gases leaving the reactor is always higher than the waste temperature and may be higher than the maximum reaction temperature, resulting in low thermal efficiency unless some mechanism is provided for utilization of that heat, (6) high temperature wall surfaces may be prone to overheating of the mineral matter in urban waste, resulting in the production of sticky deposits on wall surfaces, similar to those produced in cement, lime and taconite kilns, (7) systems where only a portion of the waste is subject to heating at one time often result in end products that see a wide range of variability in the amount of pyrolysis that has been achieved, with some material overcooked and other material relatively raw, and (8) these systems are limited by the effectiveness and availability of heating surface. A review of the prior art discloses:

U.S. Pat. No. 6,558,644 (Berman) describes a process for preparing activated carbon from urban waste. The waste is first stored to remove foreign materials and the size of the waste particles is reduced. The waste is dried under anaerobic conditions at a temperature range of 100 to 150° C. and partially pyrolyzed in a rotating, externally heated drum, at a temperature of between 140 and 400° C. The product is granulated using an extruder/mixer and the granules are carbonized under anaerobic conditions at a temperature in the range of 140 to 500° C. The carbonized granules are activated in the presence of steam and combustion gases of between 750 and 900° C. Finally, the activated granules are purified by rinsing in an aqueous hydrochloric acid solution, and subsequently drying the activated carbon.

U.S. Pat. No. 5,194,069 (Someus) discloses a method and an apparatus for the refinement of organic material. Converting and processing organic material is achieved with or without organic and inorganic additions. The base material uses animal or plant waste material, i.e. slaughter-house waste and forest industry waste. A slowly rotating waste container inside a furnace is used. Fuel for heating the cylindrical container is a mix of pyrolysis gases and purchased oil or natural gas. The reaction temperature is at 1650° F., and reduces the char to little more than carbon. The method and apparatus produces carbon powder/granulate as fuel, charcoal for grilling/smoking, activated carbon, or additives for steel production.

U.S. Patent No. 5,017,269 (Loomans et. al.) and U.S. Pat. No. 4,908,104 (Loomans et al.) disclose a method of continuously carbonizing a mixture of primarily organic waste material to a high BTU char product. A stream of comminuted municipal waste material with a substantial organic material content is fed to one end of a mixer barrel. The material is compressed to form a barrel-filling mass functioning as a first vapor block, and the work energy required to compress the waste material and squeeze out entrapped air is used to raise the temperature of the material adiabatically. Air and any steam created are vented. The material downstream from the first vapor block is decompressed in a second vent region. The material is recompressed in the absence of air to form another vapor block, while exclusively utilizing the work energy required to compress it to raise the temperature of the material adiabatically to a volatile-releasing temperature in the neighborhood of 400 to 600° F., and to carbonize the material. The volatiles are vented, and the product is discharged as a dry, particulate char. The term “adiabatic heating” suggests that there is no heat transfer into or out of the reaction chamber. Loomans states that this adiabatic compression heating process is applicable for waste materials that have been predried to a moisture content in the range of 8 to 9 percent, and which have a plastic content in the range of 4 to 8 percent.

U.S. Pat. No. 4,098,649 (Redker) discloses an apparatus and method of converting organic material such as that separated from municipal and industrial waste into useful products by using a form of an extruder in a continuous destructive distillation process, and in which the material being processed is compressed in the extruder in the absence of air, and is heated to carefully controlled temperatures in separate zones to extract different products from each of the zones. External electric resistive heating elements are used to apply heat to the outside wall of the reactor, such heat being conducted through the wall surface. Heat transfer is limited to the wall surface contacting the heating elements, and the solids must be in contact with it to be heated.

U.S. Pat. No. 3,787,292 (Keappler) describes a process and apparatus for the pyrolysis of solid wastes including a retort defining a plurality of interior temperature zones, a combustion tube disposed through the retort, a means for rotating the retort about the combustion tube, a waste infeed, a residue outlet, and at least one fluid exhaust communicating with the interior of the retort. The combustion tube is positioned down the center of what is essentially a rotary kiln, and is heated to 1500° F. Heat transfer is limited to the surface of the tube, and the solids must be in contact with it to be heated.

The conversion process of the present invention focusses instead on the maximizing of end product uniformity, weight and energy yield, while minimizing reaction temperature, energy input and processing time. It utilizes a high capacity, continuous reactor to produce large quantities of synthetic coal consistent with the end use fuel market it is intended to serve.

It is an object of the present invention to provide an improved pyrolytic process for organic waste materials.

It is a further object of the invention to introduce an improved process for the preparation of a high quality synthetic coal of uniform composition from urban waste.

It is a further object of the invention to more efficiently pyrolyze organic waste materials, to maximize the utilization of energy imparted to the reactor for pyrolysis.

It is a further object of the invention to introduce an effective means of recovering byproduct energy from the pyrolysis process, and returning it to the reactor for reuse.

It is a further object of the invention to introduce a pyrolysis system capable of continuous operation with high processing capacity, readily amenable to commercial scale large volume applications.

Other objects of the invention will become apparent as the description proceeds.

### SUMMARY OF THE INVENTION

The process of the present invention addresses each of these objectives. According to the present invention, the organic fraction of waste is converted to a high quality synthetic coal via an improved pyrolytic process. The synthetic coal has a high calorific value, tow moisture content, low sulfur content, and burning characteristics similar to naturally occurring high volatile bituminous coals.

The invention is directed to a process for the preparation of synthetic coal from organic waste comprising the steps of:
a) Sorting the waste to remove foreign materials, such as metals, glass, ceramics;
b) Reducing the size of the waste particles;
c) Pyrolysing the waste at a temperature in the range of 450 to 600° F. to produce a granulated synthetic coal having a moisture content of 3% or less;
d) Collecting and cooling the granulated synthetic coal;
e) Collecting and utilizing the byproduct oils and gases to produce mechanical energy to be imported into the pyrolysis reactor to accomplish the in-situ heating of the organic waste.

This process improvement is further optimized such that the extent of pyrolysis is adjustable by configuration of the mixing and conveying elements within the reactor, allowing for the optimization of yields between the desired synthetic coal and the remaining pyrolysis byproducts. In this process, using urban waste, the yield is set to approximately balance the energy content of the byproduct materials with the mechanical energy input needs of the reactor, including driver and other efficiency losses, minimizing the need for external fuel or other energy sources.

This process improvement is further optimized to include a system for utilization of the byproduct gases and other heat sources emanating from the reactor, as energy sources to create the mechanical work input necessary to drive the pyrolysis reactions, in a highly efficient total system.

As used herein, the following definitions are used. In-situ means that the heat is generated within the waste itself. Organic waste includes various types of waste produced in the urban and industrial environments. Such waste includes domestic waste, commercial waste, and industrial waste. Domestic waste includes waste produced in an average normal household which comprises food waste, paper products and packaging, biomass, leather, rubber, textiles, plastic products, wood, glass and metal. Commercial waste is the waste produced by the commercial sector. Much of the commercial waste is generated by food establishments, markets, grocery stores and the like. Foreign metals means materials that cannot be pyrolyzed and may interfere with the process, such as metal, glass, stones and ceramics. Unless otherwise specified, all percentages are by weight, and all ratios between various process components are also by weight.

Those skilled in the art will readily recognize and and be able to utilize the teachings herein to manufacture char, charcoal, synthetic coal and intermediate char-containing materials. For purposes of discussion in this specification, the endproduct is a synthetic coal.

For a more complete understanding of the waste conversion process of the present invention, reference is made to the following detailed description and accompanying drawings in which the presently preferred embodiment of the invention is shown by way of example. As the invention may be embodied in many forms without departing from the spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 is a block diagram of the preferred embodiment of the process for preparing synthetic coal from organic waste of the present invention.

FIG. 2 is a schematic diagram of the pyrolysis reactor and mechanical drive used in the waste conversion process for preparing synthetic coal from organic waste of FIG. 1.

FIG. 3 is a comparison of the compositions of synthetic coal products resulting from the pyrolysis of five different Refuse Derived Fuel (RDF) sources.

FIG. 4 is a comparison of the compositions of synthetic coal products resulting from the pyrolysis of a wide range of waste sources, including Refuse Derived Fuel, Industrial Waste, composting plant residues and automobile shredder residues.

FIG. 5 is a comparison of the heating values of synthetic coals produced from a wide range of waste sources, plotted as a function of the moisture and mineral matter content of each feedstock.

### DETAILED DESCRIPTION OF THE INVENTION

The conversion process of the present invention takes advantage of in-situ heating, resulting from the conversion of mechanical work to heat through the shear forces of viscous mixing. The heat so produced is used to drive the chemical reactions of pyrolysis. Mixing paddles within the reactor promote intense mixing of the waste matter, with the heat release being developed by interaction of the paddles with the waste and by interaction between waste particles themselves. As a result, there is (1) no performance penalty due to limited contact with heating surfaces, (2) uniformity of heating throughout the waste material, resulting in a product of uniform quality, (3) the ability to rapidly impart large quantities of heat to the waste material in a short period of time, resulting in a high capacity reactor, (4) the ability to achieve high levels of pyrolysis at a lower reactor temperature due to the in-situ method of heat addition, making reactor materials selection simpler, (5) avoidance of the exterior wall heat loss problem inherent in reactor designs that use a high temperature external combustion chamber to heat waste contained in an internal reaction chamber, and (6) avoidance of combustion product heat losses to the stack in reactors that rely on transfer of heat from combustion products to the waste materials. Because heat is produced uniformly throughout the mixing volume of the reactor, scaling of reactor size becomes a function of reactor volume rather than heating surface area. Capacity of the reactor then varies approximately with the cube of the diameter rather than the square, as is the case with heated surface systems, resulting in a much greater economy of scale.

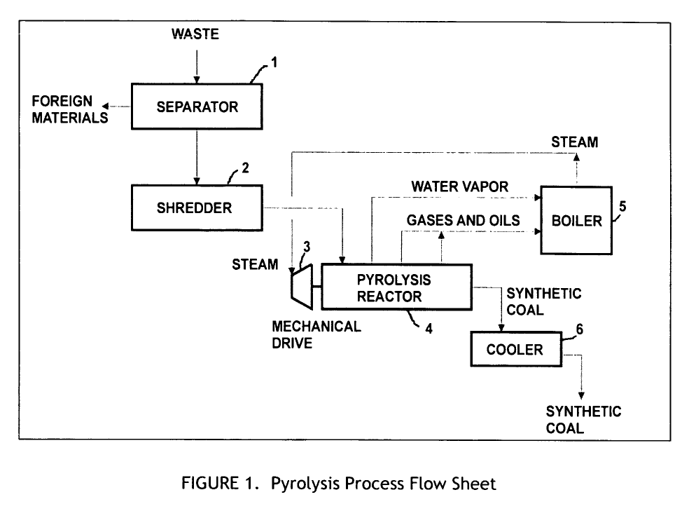

Referring now to FIG. 1, the preferred embodiment of the system of the present invention for converting organic waste materials into synthetic coal product, comprises a separator 1, a shredder 2, a mechanical drive unit 3, a reactor 4, a boiler 5, and a cooler 6.

The separator 1 sorts waste material suitable for pyrolysis from waste material not suitable for pyrolysis. The waste is then shredded to a particle size of about 5 cm in diameter. The shredded waste material is directly transferred to the mechanical feeder 8 at the drive end of the pyrolysis reactor 4. The drive unit converts energy generated from the byproduct oils and gases in the conversion process into mechanical work necessary to drive pyrolytic conversion in the reactor. The mechanical drive unit is commercially available from Murray Turbomachinery Corp. of Burlington, Iowa.

The reactor has an extruder design, using a plurality of co-rotating mixers. The mixers impart mechanical work to the waste material as it is moves through the reactor. The reactor includes a drying zone 9, and preferably two pyrolytic mixing zones (10, 11). The waste material is heated in the drying zone 9 and moisture is removed and exhausted through a first reactor vent 12. The pyrolytic zones are positioned downstream of the drying zone 9. Pyrolysis occurs in the following mixing zones (10, 11), with a region following each zone which allows for the release of pyrolysis oils and gases through vents (13, 14) atop the reaction vessel. The boiler 5 uses byproduct oils, gases, and/or vapors from the reactor to recover energy for recycling through the reaction process. The boiler uses vortex burners that are commercially available from T-Thermal of Blue Bell, Pa.

The waste material is compacted within the drying and pyrolytic zones to form a mass of moving treated material filling the cross section of the reactor and functioning as a barrier to contain vapors within these zones. Mixing mechanisms disposed within the drying and pyrolytic zones heat the treated material while extending the residence time of mixing. The reactor downstream of an oil vent includes a combination of forwarding and reversing mixing elements to move the treated material to a reactor discharge port.

The remaining solids are conveyed to the discharge end of the mixing reactor, where they are then delivered to an enclosed contact cooler 6, having a water cooled conveying screw. This cooling system reduces the temperature of the synthetic coal product in an oxygen-free environment, without direct contact with process water, stopping the pyrolysis reaction while preventing the possibility of combustion of the hot synthetic coal. The synthetic coal cooler is commercially available from Metso Minerals, Inc. of Milwaukee, Wis.

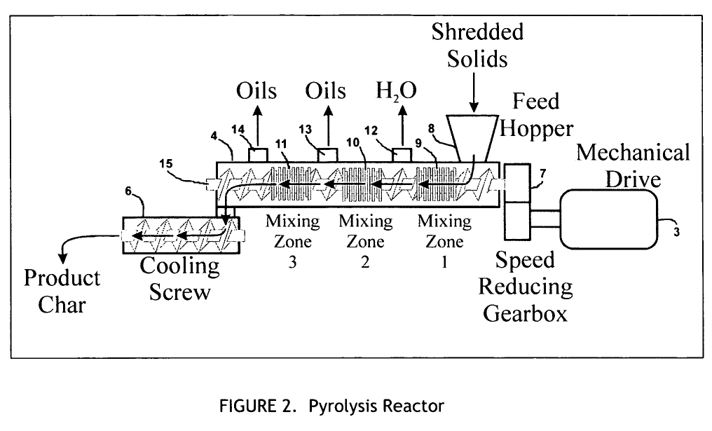

Referring now to FIG. 2, the reactor 4 is a high intensity mixer extruder design, commercially available from B&P Process Equipment Company of Saginaw, Mich. The reactor uses multiple co-rotating mixing augurs of overlapping design to transport the waste through the vessel and to impart the mechanical work to the waste material. Three mixing zones (9, 10, 11) along the reactor volume deliver the work energy to the waste material within the reactor to accomplish drying and pyrolysis. Within these zones, the material is compacted to form a mass of moving material filling the cross section of the reactor and functioning as a barrier to contain vapors within each zone.

Each zone includes some or all of the following screw elements in combination: forwarding screw sections to transport solids into the mixing zone; sequential mixing paddles arranged in a forwarding helical array to shred, heat and compact the solids into a plug that fills the cross section of the mixing chamber; an array of sequential mixing paddles arranged at 90° to impart mechanical mixing energy to the solids, but without forwarding or compaction; sequential mixing paddles arranged in a reversing helical array to both heat and retard the flow of solids, to extend the residence time of mixing; and reversing screw sections, to further extend the residence time of mixing and to assist in keeping the cross section of the mxing zone filled with solids. The configuration of screw elements varies from zone to zone, and with the type of feedstock being processed. The final section of the reactor, downstream of the third vent, contains a combination of forwarding and reversing conveying screw elements, to move material to the discharge end of the reactor while at the same time creating a barrier to contain vapors within the reactor.

The first zone 9 heats the waste material to the range of 220 to 260° F., to remove moisture. The water vapor so produced is removed through a vent 12 at the top of the reactor, immediately following the first mixing zone 9, where compaction is relieved and the solid material is transported past the vent 12 without filling the reactor cross section, so as to allow separation of solids and vapors. Pyrolysis occurs in the following two mixing zones (10, 11), with a region following each zone which allows for the release of pyrolysis oils and gases through vents (13, 14) atop the reaction vessel. The material temperature in the pyrolysis zone reaches from between 450 and 600° F. Drying and pyrolysis combined take approximately 90 seconds. The finished synthetic coal is transported by the mixing augurs to the discharge port at the end of the reactor vessel, where its temperature is reduced using a water-cooled screw conveyor 6.

The byproduct oils produced by this low temperature process are relatively light and free flowing, even at room temperature, contrasting them with much heavier, viscous oils produced by high temperature pyrolysis processes and gasification processes. The oils resulting from pyrolysis of the organic waste are typically low in sulfur, low in ash, and have a heating value in the range of 10,000-12,000 Btus/pound.

In the preferred embodiment of this process, byproduct oils and gases from the two reactor pyrolysis zone vents are conveyed in vapor phase, without cooling, directly into a refractory-lined combustion chamber, where they serve as the primary fuel source. Water vapor from the reactor drying zone vent is combined with combustion air entering this same chamber. A small amount of pilot fuel is used to start the byproduct oil and gas ignition process and to balance the energy needs of the pyrolysis process, as required. For urban waste, however, the process is optimized such that the energy content of the vent gases and oils closely approximates that needed to drive the pyrolysis reactor, when all process and drive inefficiencies are accounted for. In the alternative, the energy content of a portion of the char produced in the reactor is converted to mechanical work for the purpose of driving pyrolytic conversion in the reactor.

The combustor operates at a temperature in excess of 2700° F., for a residence time in excess of 1 second, to ensure thorough combustion of the hydrocarbons. Combustion products enter a boiler system 5 optimized to maximize the energy recoverable from the superheated steam, while minimizing the risk of high temperature acid gas corrosion. The steam is directed to a condensing steam turbine mechanical drive 3 which delivers the mechanical energy to the pyrolysis reactor. In the alternative, the steam turbine may drive an electric generator, which provides electric power for use by an electric motor drive on the pyrolysis reactor. Any surplus power thus generated can be used by conveyors, shredders and other waste separation equipment within the plant.

The synthetic coal obtained from urban waste by the process of the present invention has a calorific value of approximately 9,000-10,500 Btus/lb, a moisture content of 2% or less, and a sulfur content of approximately 0.2%. The material is granular, and may be directly burned or blended with natural coal for use in boilers and other combustion systems.

The following examples are illustrative of a plurality of preferred embodiments of the present invention, and are representative of actual test data with reference to FIG. 1, which is a block diagram of the process. The following examples are not to be construed as limiting, it being understood that a skilled person may carry out many obvious variations to the process.

### EXAMPLE 1

Initially, 2000 pounds of urban waste are sorted to remove foreign material (FIG. 1), and shredded to produce approximately 1500 pounds of organic matter equivalent to Refuse Derived Fuel (RDF). The shredded waste material is fed by metered conveyor to the feed port of the pyrolysis reactor 4 (see FIG. 2), where it is conveyed and compacted by the internal reactor augurs 15, which deliver it to the first mixing zone 9. Here intense mixing converts mechanical work into direct in-situ heating of the waste materials through shear forces within the viscous material. During the short period where the waste is maintained within the first mixing zone 9, the temperature of the waste is increased to approximately 260° F., liberating moisture in the form of water vapor. The waste Leaves the mixing zone, passing into an area without compaction, which permits the vapors and solids to separate, with the water vapor leaving the reactor from a vent 12 on its top surface, at a temperature of approximately 260° F.

The waste is again compacted, and transported to the first of two pyrolysis zones 10. Again intense mixing by elements of the augurs 15 convert mechanical work into in-situ viscous heating, raising the temperature of the waste materials to approximately 450 to 500° F. After approximately 30 seconds, the partially pyrolized waste has been conveyed through the second mixing zone 10, where it again enters a zone without compaction. Here pyrolysis byproduct oils and gases are liberated from the solids and leave the reactor in vapor phase through a second vent port 13 on the top.

A third stage of compaction and mixing 11 occurs, raising the temperature of the waste materials to approximately 500 to 600° F., more fully pyrolyzing the waste materials. After approximately 30 seconds of in-situ heating and pyrolysis, the material is conveyed to a final uncompacted de-gassing zone, in which byproduct oil and gas vapors are liberated. A third vent port 14 on the top of the reactor allows for the removal of these byproduct materials. The remaining solids are conveyed to the discharge end of the mixing reactor, where they are then delivered to an enclosed contact cooler 6, having a water cooled conveying screw. This cooling system reduces the temperature of the synthetic coal product in an oxygen-free environment, without direct contact with process water, stopping the pyrolysis reaction while preventing the possibility of combustion of the hot synthetic coal. Since the cooling water does not contact the char directly, a potential waste water stream is eliminated. In the preferred embodiment of this process, heat recovered from the cooling system is utilized for boiler feedwater heating.

The solid product of pyrolysis, weighing about 830 pounds, is similar in appearance to granular coal, has a moisture content of less than 2%, a calorific value of approximately 9,500 Btus/pound, and a sulfur content of approximately 0.2%. It is easily ignitable, and exhibits a burning profile similar to high volatile bituminous coal. The material may be transported, stored, pulverized and burned in a manner similar to natural coal, and may also be blended with natural coal for boiler and other combustion applications.

### EXAMPLE 2

An industrial waste of approximately equal parts of cardboard, waste wood and mixed plastics, is shredded and fed to the reactor. The solid product of pyrolysis, approximately 54.8 percent by weight of the initial feedstock, is granular in nature, and has had a moisture content of approximately 1.1%, a calorific value of approximately 11,470 Btus/lb, and a sulfur content of approximately 0.06%. The oils produced from this feedstock exhibited a specific gravity of 1.12, and a viscosity of 5.1 centipoise at 60° F., roughly comparable to kerosene.

### EXAMPLE 3

A mixture of composting plant reject materials, including sand, grit, broken glass, as well as cardboard containers, mixed plastics, leather goods, soiled diapers and other waste materials, is shredded and fed to the reactor. The solid product of pyrolysis, approximately 64 percent by weight of the initial feedstock, is granular in nature, has a moisture content of 0.6%, a calorific value of approximaterly 8,150 Btus/pound, and a sulfur content of approximaterly 0.2%. The oils produced from this feedstock are free flowing at room temperature, and have a moisture-free calorific value of approximately 11,650 Btus/pound.

### EXAMPLE 4

A sample of commercial automotive shredder residue is sorted to remove tramp metal, shredded and fed to the reactor. The solid product of pyrolysis, approximately 80.6 percent by weight of the initial feedstock, is granular in nature, had a moisture content of 0.54%, a calorific value of approximately 6,650 Btus/pound, and a sulfur content of 0.2%.

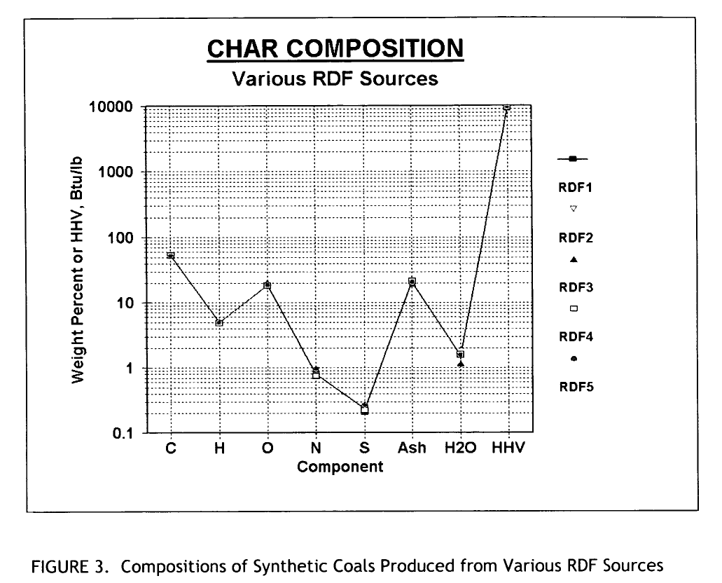

Because of the uniform heating and intense mixing that are achieved in this process, the char produced is very uniform in composition, and feedstocks of similar origin produce very similar char products. FIG. 3 plots the ultimate analysis (weight percent Carbon, Hydrogen, Oxygen, Nitrogen, Sulfur, Moisture and Ash) and higher heating value of chars produced from various commercial Refuse Derived Fuels (RDF). The samples show remarkable similarity in composition and heating value.

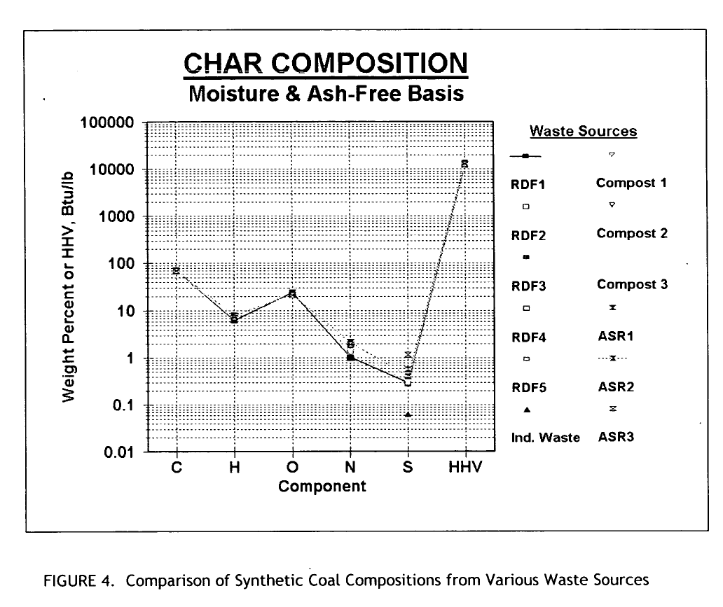

The in-situ viscous heating method allows for successful operation on a much wider range of waste materials than are suitable for many other processes. These waste materials include industrial wastes, compost stabilate, automobile shredder residue, tire chips, waste water treatment sludge, and other organic waste sources. Synthetic coal products have been successfully made with feedstocks ranging from 4 to 56 percent moisture, 2 to 57% ash, and from zero to about 30% plastics. Again the remarkable uniformity of composition of the synthetic coal produced by this process is seen, when coal products from a wide range of waste sources are compared. FIG. 4 plots the elemental components and higher heating value of synthetic coals produced from five different RDF samples, one mixed industrial waste, three composting plant waste mixtures and three automobile shredder residue sources. When expressed on a moisture- and ash-free basis, the compositions of these synthetic coals appear very similar.

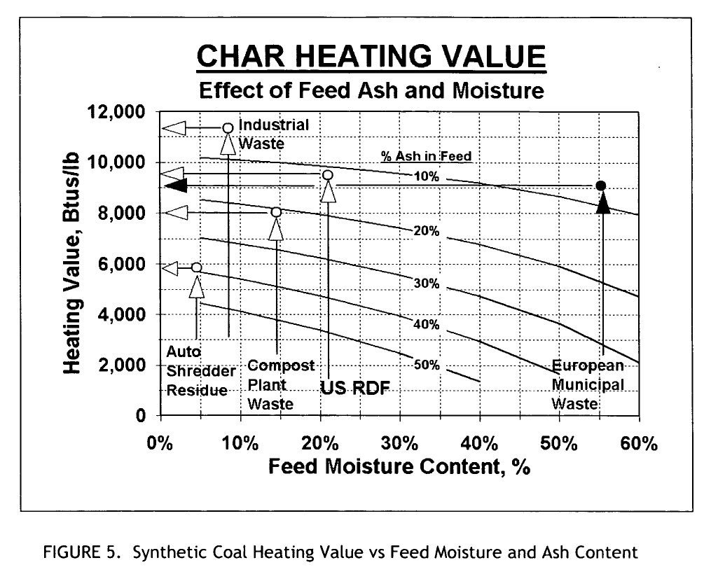

The consistancy of residence time, temperature and intense mixing inherent in this process allows for fairly accurate prediction of the fuel qualities for a given synthetic coal, if the mineral matter and moisture content of the waste sample is known. FIG. 5 illustrates the higher heating value observed in of a number of actual char products, as plotted against their feedstock moisture and ash (mineral matter) content. As an example, U.S. refuse derived fuel having a moisture content of 21% and an ash content of 12% by weight produces a synthetic coat having a higher heating value of approximately 9,500 Btus/lb. A very high moisture municipal waste from a Mediterranean source produced a coat of roughly comparable heating value, white a dry, low-ash industrial waste high in plastics content produced a coat of superior heating value. Low grade wastes such as automobile shredder residue produced synthetic coat of lesser quality.

Throughout there are various patents referenced by patent number and inventor. The disclosures of these patents in their entireties are hereby incorporated by reference into this specification in order to more fully describe the state-of-the-art.

It is evident that many alternatives, modifications, and variations of the waste conversion process of the present invention will be apparent to those skilled in the art in tight of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

I claim:

1. A process for the preparation of char, the process comprising:
a. utilizing waste product, the waste product including at least some organic materials;
b. separating at least some organic materials from inorganic materials in the waste product;
c. shredding the separated organic materials;
d. pyrolyzing the separated organic materials at a pyrolytic temperature in a pyrolysis reactor, the pyrolytic temperature being between 450° F. and 600° F., the separated organic materials being reduced to a granular char product by in-situ heating and mixing caused by the pyrolysis reactor, liquid byproducts and gaseous byproducts of the separated organic materials being formed during the pyrolyzing; and
e. utilizing the liquid byproducts and the gaseous byproducts of the sorted organic materials for production of mechanical work, the mechanical work being used in pyrolyzing the separated organic material in the pyrolysis reactor.

2. The process according to claim 1, whereby the separated organic material is dried and pyrolized in a single reactor.

3. The process according to claim 1, whereby the pyrolysis reactor includes a twin screw mixer, friction shear forces of mixing being used to produce the in-situ heating of the separated organic material.

4. The process according to claim 1, whereby the char has an ash content between 9% and 20%.

5. The process according to claim 1, whereby the char has a gross calorific value between 9,000 Btus/pound and 10,500 Btus/pound.

6. The process according to claim 1, whereby the char has burning characteristics comparable to high volatile bituminous coal.

7. The process according to claim 1, whereby the gaseous byproducts include byproduct water vapor and byproduct oils, the byproduct water vapor being removed from the pyrolysis reactor through a first vent, the byproduct oils being removed from the pyrolysis reactor through a second or subsequent vents.

8. The process according to claim 7, whereby the byproduct oils, gases and sensible heat are utilized in a boiler to produce mechanical work.

9. The process according to claim 1, whereby pyrolytic energy requirements are met by introducing mechanical energy, the mechanical energy being converted to in-situ heating of the separated organic material within the pyrolysis reactor.

10. The process according to claim 1, whereby the in-situ heating within the pyrolysis reactor enables heating and conversion of the organic materials without limitations in reaction rate imposed by transfer of heat through reactor walls and other surfaces.

11. The process according to claim 1, whereby the in-situ heating within the pyrolysis reactor enables conversion of the separated organic materials without limitations in product uniformity imposed by delivery of heat by conduction through contact with reactor wall surfaces.

12. The process according to claim 1, whereby the in-situ heating within the pyrolysis reactor provides for scaling of reactor capacity based upon reactor volume.

13. The process according to claim 1, whereby the heating of the waste materials for pyrolysis is accomplished with minimal risk of ash softening and deposition on reactor walls and other heating surfaces.

14. The process according to claim 1, whereby the in-situ viscous heating of the separated organic materials minimizes the loss of heat from the reactor, improving conversion efficiency.

15. A process for preparation of synthetic coal from solid waste, the process comprising:
a. removing foreign materials from the solid waste, the foreign materials selected from the group consisting of metals, glass, ceramics, and other inorganic materials;
b. reducing particle size of the solid waste without the foreign materials;
c. pyrolyzing the solid waste without the foreign materials in a pyrolysis reactor at a temperature between 450° F. and 600° F. to produce a granulated synthetic coal, the granulated synthetic coal having a moisture content of 3% or less, byproduct oils and byproduct gases being formed in the pyrolyzing;
d. collecting and cooling the granulated synthetic coal; and
e. utilizing the byproduct oils and the byproduct gases to produce mechanical energy, the mechanical energy being imported into the pyrolysis reactor to accomplish in-situ heating of the waste product without the foreign materials.

16. A system for converting organic waste material to a synthetic coal product, the organic waste materials selected at least in part from the group consisting of plastics, wood, biomass, textiles, pulp and paper, cardboard, leather, and rubber, the waste conversion system including a reactor and comprising:
a. a separator for sorting waste material suitable for pyrolysis from waste material not suitable for pyrolysis;
b. a drive unit for converting energy generated from the byproduct oils and gases in the conversion process into mechanical work necessary to drive pyrolytic conversion in the reactor through in-situ heating;
c. the reactor having an extruder, the reactor using a plurality of co-rotating mixers to impart mechanical work to the sorted waste material being transported therethrough, the reactor including a drying zone, the sorted waste material being heated in the drying zone for moisture removal through a first reactor vent, the reactor having one or more pyrolytic zones, the one or more pyrolytic zones being disposed downstream of the drying zone, pyrolysis occurring in the one or more pyrolytic zones, the pyrolysis enabling the release of fluid through one or more reactor vents, the sorted waste material being compacted within the drying zone and the one or more pyrolytic zones to form a mass of moving treated material filling the cross section of the reactor and functioning as a barrier to contain vapors within the drying and pyrolytic zones, a plurality of mixing mechanisms disposed within the drying and pyrolytic zones, the plurality of mixing mechanisms heating the mass of moving treated material while extending the residence time of mixing the mass of moving treated material, the reactor downstream of an oil vent having a combination of forwarding and reversing mixing elements to move the mass of moving treated material to a reactor discharge port; and
d. a boiler for utilizing byproduct oils, gases, or vapor from the reactor to recover energy for recycling through the reaction process.

17. The system of claim 16, further comprising a shredder to reduce the size of the sorted waste material prior to processing in the reactor.

18. The system of claim 16, further comprising a synthetic coal cooler, the synthetic coal cooler being disposed downstream of the reactor, heat recovered from the synthetic coal cooler being used for heating feedwater entering the boiler.

19. The system of claim 16, wherein the pyrolytic zone comprises more than one distinct heating zone.

20. The system of claim 16, wherein a barrier disposed between the cooling water and the synthetic coal eliminates a potential waste-water stream.

21. A system for converting organic waste materials into a char product, the organic waste materials selected at least in part from the group consisting of plastics, wood, biomass, textiles, pulp and paper, cardboard, leather, and rubber, the waste conversion system including a reactor and comprising:
a. a separator sorting waste material to be converted into the char product from waste material not to be converted;
b. a drive unit for converting energy generated from the byproduct oils and byproduct gases into mechanical work necessary to drive pyrolytic conversion in the reactor through in-situ heating;
c. the reactor having an extruder, the reactor using a plurality of co-rotating mixers to impart mechanical work to the sorted waste material being transported therethrough, the reactor including a drying zone, the sorted waste material being heated in the drying zone for moisture removal through a first reactor vent, the reactor having one or more pyrolytic zones, the one or more pyrolytic zones being disposed downstream of the drying zone, pyrolysis occurring in the one or more pyrolytic zones enabling the release of fluid through one or more additional reactor vents, the sorted waste material being compacted within the drying and pyrolytic zones to form a mass of moving treated material filling the cross section of the reactor and functioning as a barrier to contain vapors within the drying and pyrolytic zones, mixing mechanisms disposed within the drying and pyrolytic zones heating the mass of moving treated material while extending the residence time of mixing, one or more vents a vent for discharging oils from the one or more pyrolytic zones, the reactor downstream of the one or more vents oil vent having a combination of forwarding and reversing mixing elements to move the mass of moving treated material to a reactor discharge port; and
d. a boiler for utilizing byproduct oils, gases, or vapor from the reactor to recover energy for recycling through the reaction process.

22. The system of claim 21, further comprising a shredder to reduce the size of the sorted waste material to be converted.

23. The system of claim 21, further comprising a char cooler, the char cooler being disposed downstream of the reactor, heat recovered from the char cooler heating feedwater entering the boiler.

24. The system of claim 21, wherein the reactor includes at least two distinct pyrolytic zones.

25. The system of claim 21, wherein a barrier disposed between the cooling water and the char eliminates a potential waste-water stream.

26. The system of claim 21, further comprising a mechanism for utilizing the energy content of materials produced in the reactor for conversion to mechanical work to drive pyrolytic conversion in the reactor through in-situ heating.
